(19) United States
(12) Patent Application Publication
(10) Pub. No.: US 2009/0113873 A1
(43) Pub. Date: May 7, 2009

(54) Continously air breathing assisted jet engine linear aerospkie rocket

(76) Inventor: Erik Henry Tweeton, Granby, CO (US)

Correspondence Address: Erik H. Tweeton, PO Box 1663, Granby, CO, 80446, US

(21) Appl. No.: 11/362,550

(22) Filed: Feb. 27, 2006

Related U.S. Application Data
(60) Provisional application No. 60/661,821, filed on Mar. 16, 2005.

(51) Int. Cl. F02K 5/00

(52) U.S. Cl. 60/246

(57) ABSTRACT

A linear aerospike rocket engine receives continuous air breathing assistance from an oxygen turbopump powered axial flow air compressor and side mounted integrated adjustable ramp shape ramjets. The preferred embodiment receives all its thrust from air breathing during the start to about 1.95 kilometers per second (4300 mph) up to 20 miles altitude. It uses about 50% of the thrust from air breathing from 1.95-3 klm/second (4300-6700 mph). It uses about 10% of the thrust from air breathing engines at 30 miles altitude. It uses rocket turbines for powering the air compressor or the liquid oxygen pump, but not simultaneously.

### CROSS REFERENCE TO RELATED APPLICATIONS

This application claims the benefit of U.S. Provisional Application number 60/661,821 filed Mar. 16, 2005, the disclosure is incorporated herein by reference.

### BACKGROUND OF THE INVENTION

1. Field of Invention

This invention relates to space plane engines and more specifically combinations of air breathing and rocket engines for single stage to orbit vehicles such as ramjets, linear aerospike rockets and turbojets with axial flow air compressors.

2. Description of Prior Art

The prior engines for single stage to orbit vehicles include only rockets, or an air breathing only airplane used as a first stage with the rocket powered vehicle on top. No prior engine was able to show a continuously air breathing assisted engine. All other thrust producing engines were separate from each other and therefore were more complex and had less thrust to weight and less ISP or fuel efficiency. Other prior ideas use a combination of separate jet turbines, ramjets, scramjets, and rockets. That combination is more inefficient, complex, and expensive. The all rocket single stage to orbit vehicle needs about 10 times its structure weight in fuel to achieve orbit, but the invention described herein only needs 6.

### BRIEF SUMMARY OF THE INVENTION

The primary objective of the invention is a thrust producing engine with maximum average ISP from sea level to space. The ISP is the pounds of force of thrust per pound of fuel burned per second. Another objective of the invention is to have an engine with the maximum thrust to weight ratio. A further objective is to have the engine be as simple and cheap to make with minimum quantity and size of parts and minimum cost within the performance boundaries required for single stage to orbit vehicles. Other specific objectives will become apparent from the combination of the drawings and detailed descriptions of the drawings.

### BRIEF DESCRIPTION OF SEVERAL VIEWS OF THE DRAWING

FIG. 1 is a view of prior art.

FIG. 2 is a cutaway view of the basic components.

FIG. 3 is a close up of the midsection of the engine.

FIG. 4 is a rear view of a typical space plane with the engine attached.

### DETAILED DESCRIPTION OF THE INVENTION

Detailed descriptions are provided herein, however the present invention can be assembled in other ways, so the specific details are a basis for the claims and to explain how to create the invention and not intended as limiting to the particular defined embodiment. The claims are intended to cover such modifications and alternatives included within and scope of the invention.

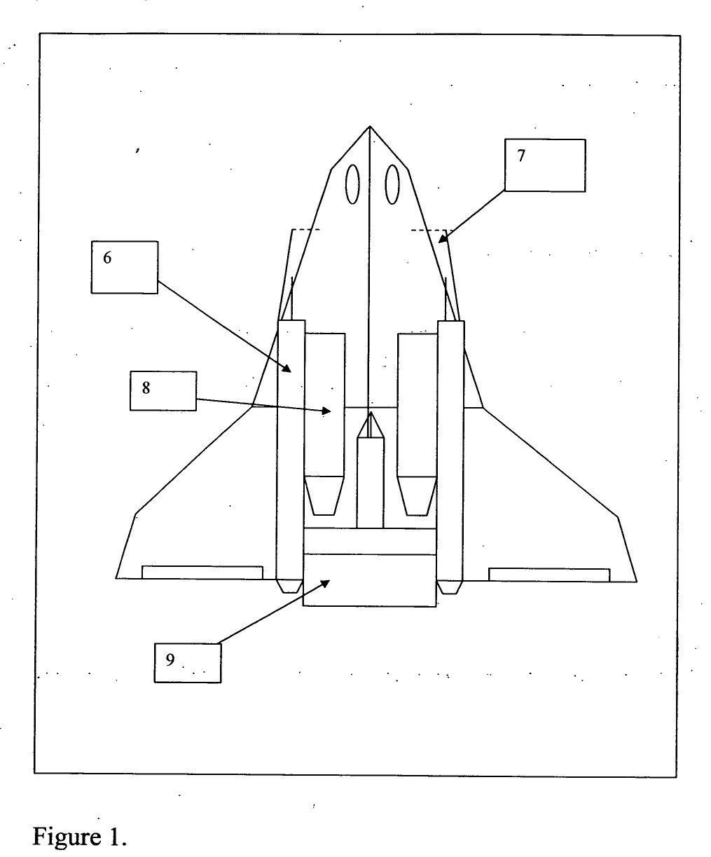

Turning first to FIG. 1, which is prior art, #7 is the main air intake for the air breathing engines. They close when the engine is only using rocket power. The engines needed to take off from a runway are turbojets and are shown as #8. The vehicle requires separate ramjets #6. Number 9 is the linear aerospike rocket engine. These separate engines operate independently with minimal shared components.

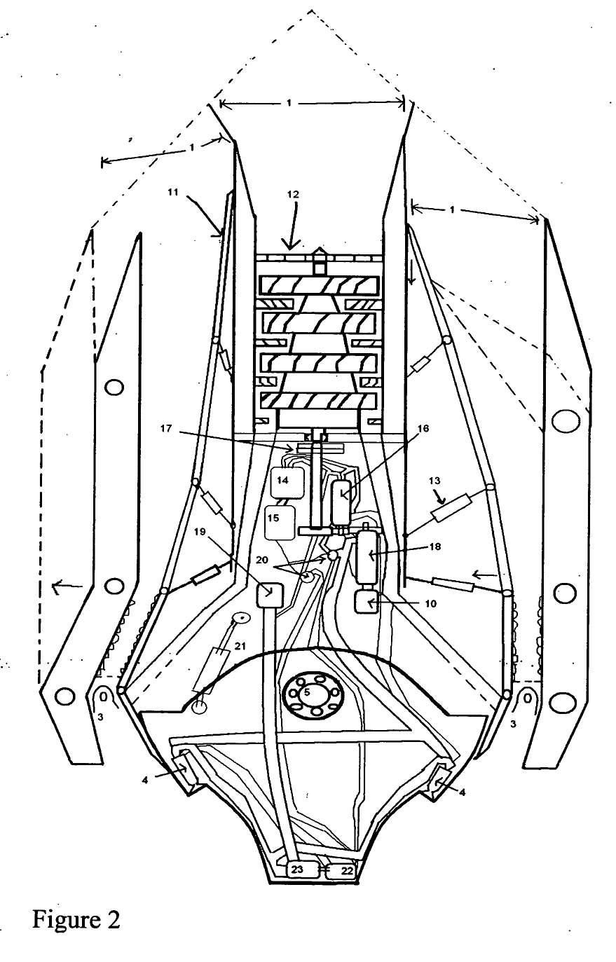

FIG. 2 is the view of the main components of the current invention. The machine described is for generating thrust at all altitudes and speeds for a single stage to orbit space plane comprising: a frame to connect the following components, 2 symmetrical adjustable air intake compression ramps, an axial flow air compressor, a linear aerospike nozzle, 2 air breathing combustors, 1 liquid hydrogen turbopump, 1 liquid oxygen turbopump, 1 clutch for the air compressor, several linear actuators, and a auxiliary power unit with control system. Because the invention is a continuously air breathing assisted jet engine/linear aerospike rocket, its acronym is “cabajelar”, and may be referred later in this specification by that name.

Like a linear aerospike liquid fueled rocket motor, it used liquid fueled turbo pumps to create the pressure to propel the main fuel source; liquid hydrogen and liquid oxygen in to the 2 linear nozzles attached to the ends of the linear aerospike. However, unlike a normal linear aerospike liquid fueled rocket motor, it uses the oxygen turbopump to drive the axial flow air compressor at a vehicle speed of mach 2 or less. It takes about 29% of the total hydrogen fuel consumption per second to drive the compressor at take off speed of 100 meters per second (220 feet/second). Each turbopump burns a 1 to 1 mixture of hydrogen and oxygen so only ⅛^{th} of the hydrogen gets burned. The hydrogen rich exhaust from the turbopump can provide some of the fuel needed by the air burning engines, while the rest of the fuel supplied is from the output of the fuel pump. The turbo pumps need to burn about half a kilogram of hydrogen burned per second to drive the air compressor for the sample 26 meter long plane that needs 150000 newtons (34000 lbs) of thrust at takeoff. The compressed air is injected to the outer combustors which are also used by the ramjets and they can be used at the same time since the pressure ratio for the compressor is higher than the ramjet ratio at the vehicle speeds which the air compressor provides most of the air for combustion. The compressor ratio is 21:1. That is more than the 1.7 to one the ramjet produces at 300 meters per second (660 mph) when the ramjet can first propel the vehicle, and more than the 7:1 the ramjet produces at 600 m/s (1,320 mph). The compressor does not provide anymore air supply at more than mach 2 vehicle speed. 100121 The liquid hydrogen, which may be referred to in this application by the name “lihy” is directed to the ramjet combustors when the engine is using air as the oxidizer, but is directed only at the rocket combustors when the air is too thin for a ram or scram jet to provide sufficient thrust. The rocket burns 126 kilograms (280 lbs) per second when the engine operating only with rockets, if for the 26 meter (85 feet) long plane used as a sample for proportional purposes in this application.

The turbo pumps only need to burn about 1/10^{th} of what it needs to pump the rocket fuel compared to drive the air compressor. The scramjet and rocket can operate simultaneously, which allows the 2 engines to share the job of providing thrust at the altitudes after the scram cannot provide 100% of the thrust needed. The engine uses ram compressed air at mach 1-8 and lihy fuel. At mach 1-2, the ISP is about 6000-7000. At mach 4, it gets about 5000 ISP and about 3000 at higher speeds. It starts to use lox at speeds more than mach 6.6 at 30 kilometers (19 miles) altitude with air breathing engines providing 10% of the thrust when the vehicle reaches 48 kilometers (30 miles) altitude. The scramjet assists the rocket until it dies out completely from lack of air. Even with the air breathing engine only producing 10% of the thrust at 30 miles altitude, the ISP increases from 445 to 670 since the ISP of the ramjets and scramjets at mach 6-10 is about 3000. It uses rocket lihy and lox from mach 10, 3045 meters per second (6700 mph) to orbital speeds 7900 m/s (17500 mph). For a 26 meter (85 feet) long 5 meter (16 feet) high vehicle with 0.1 drag coefficient, the engine has 20 times its weight in thrust, and gets an average ISP of 2200 by burn time, based on a 20m/s (66 feet per second) squared acceleration from mach 2 to orbital speed, 10 m/s acceleration from mach 1-2, and 5 m/s acceleration from 0-mach 1.

The linear aerospike shape rocket gets 372 ISP thrust at sea level and 445 at 31 kilometers (19 miles) altitude with only a 6.26 MPA (908 PSI) main combustion pressure. Since the rocket is off at sea level, an alternative embodiment uses a standard bell shaped nozzle, with the ramjet exhaust still being a linear aerospike shape outside of the bell nozzle.

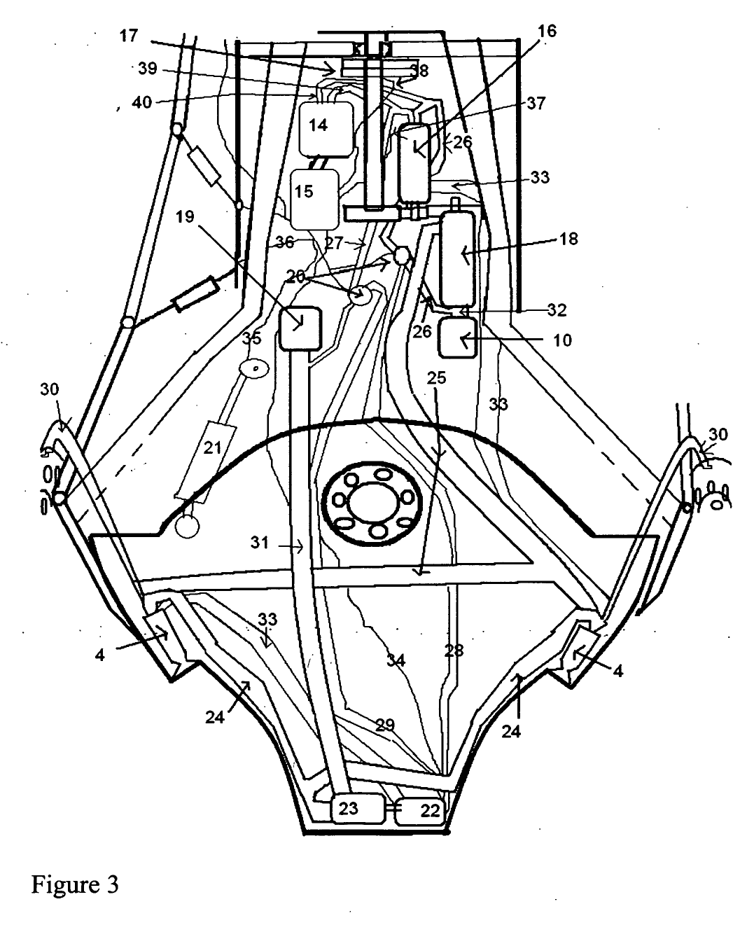

Here are the identifications of the components for FIG. 2. Number 10 is the main lox intake. Number 11 are the movable air compression ramps for the ramjets that convert into scramjets. Number 12 is the axial flow air compressor that is in between the ramjet/scramjets. It need to be about 3 times as large as the drawing shows to be proportionally correct for the sample 26 meter long 5 meter high plane. Number 13 are the electric ball screw pushrods to change the shape of the air compression ramps from a ramjet to a scram jet. Also the shock wave isolators which are located in front of the throat of the ramjet nozzle can be slid out of the way under a smooth surface when the ramjet is operating. Number 14 is the fuel cell auxiliary power unit which takes lihy and lox from the low pressure lines 39 and 40 in FIG. 3. Number 14 is connected to 15 which is the battery and control computer. Number 16 is the oxygen pump turbine which drives the axial flow air compressor when the vehicle is traveling up to speeds of mach 2, and then drives the lox pump #18 to supply the rocket main combustion chambers. The liquid oxygen turbopump turbine drives the main lox pump or the axial flow air compressor, but not at the same time.

A clutch controls the axial flow air compressor #17 instead of a gear engagement to reduce the stresses on the oxygen turbine #16 when it is engaged or disengaged. The main lihy intake connection is #19. The electric mini pumps are #20 to push the fuel and oxygen for the turbines 16 and 22. The gimble actuator is #21 and moves the exhaust nozzle up and down to steer the vehicle and separate throttles are used to steer the vehicle for yaw vehicle direction. They are controlled by the computer 15. Number 22 is the lihy turbine which drives #23 the lihy pump which pushes fuel for both the air breathing engines and the rocket.

FIG. 3 is the close up of the various fuel lines and moving components. Number 24 is the high pressure lihy line which provides all the fuel for both the rocket and the air breathing engines. The high pressure line for the lox is #25, which only goes for the rocket. The lox low volume low pressure line is #26 from the small pumps 20 to the lox turbine 16. The lihy line is #27 to the lox turbine #16. The turbines 16 and 22 burn a mix of 1:1 (by weight) of lihy and lox and the exhaust is a hydrogen-gas-rich and water steam gas that is sent to the main rocket combustors #4. Number 28 is the lox line that supplies the lihy turbine #22, and #29 is the lihy line that supplies #22. The high pressure lines are #30 that supplies the scramjets, which can only operate on hydrogen fuel. They have a flexible joint in the middle to accept the gimble motion of the main nozzle assembly. Number 31 is the main lihy lowest pressure supply hose from the connector #19 to the pump #23 intake. Number 32 is the main supply hose that connects #10 to #18. Number 33 are the turbine exhaust pipes that go from both turbines 16 and 22 to the main rocket combustors #4. The total size of the exhaust expansion ramp needs to be about 12 meters (39 feet) wide and 5 meters (16 feet) high to get the thrust need to propel the sample 560,000 newtons (127,000 pounds) of thrust when the vehicle cannot use air breathing assistance any more.

Number 34 is the control cable for the lihy turbine #22 from #15. Number 35 is the control cable for #21, the gimble actuator. #36 is the control cable for the #11 ramp shape changing actuators #13. Number 37 is the control cable for the lox turbine #16. Number 38 is the clutch control cable for the clutch #17. Number 39 is the fuel cell line that supplies the hydrogen and #40 is the line that supplies the oxygen for the fuel cell #14.

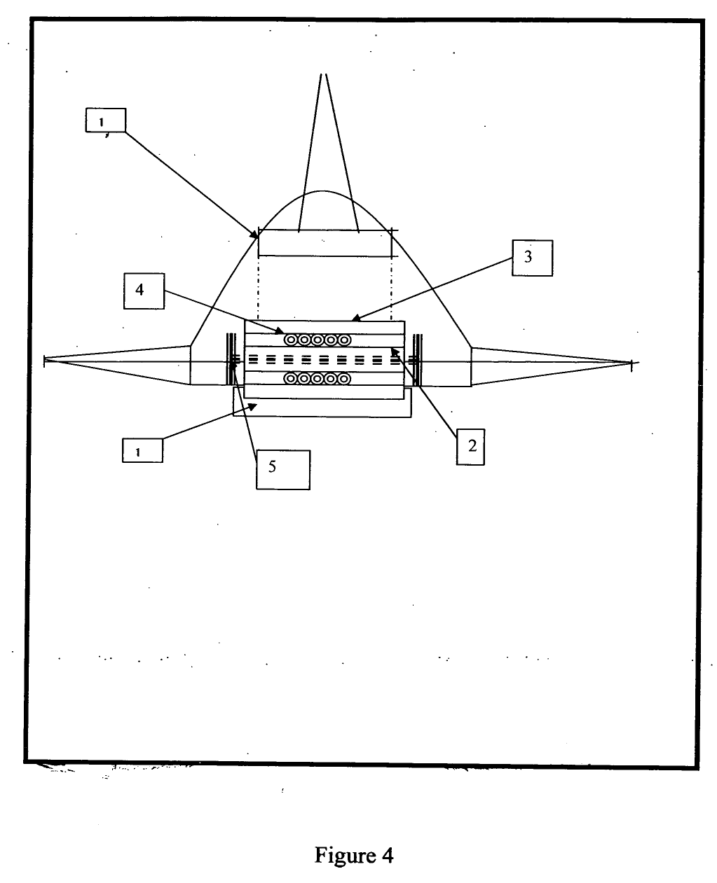

FIG. 4 shows the preferred way to fit the engine on a typical space plane. The air intake areas are #1 which can open or close. The main nozzle assembly is #2 which has the exhaust expansion ramps for both the rocket and the air breathing engines. Number 3 is where the air breathing engine combustor is located, but the exhaust continues to expand along #2 while #2 gimbles. The size of the throat of the #3 nozzle needs to be about 1.68 meters squared (18 square feet) to produce just the thrust to counter drag and needs to be about 4 square meters (43 square feet) to get a 10 m/s acceleration at mach 4. It needs to be able to handle a gas temperature of 3600 K (6000 F) to get the thrust claimed in the previous sentence. Number 4 are the main combustors for the rocket. There are a total of 10 assembled in 2 rows along #2. They have separate throttles on the same side of the row of combustors to control vehicle yaw. Number 5 is the axle on which #2 moves side to side (gimbles).

What is claimed to be new and desired to be secured by United States Patents:

1. A single thrust producing engine that has either air breathing operation or continuous air breathing assistance to a rocket at all altitudes comprising of: an outer frame to connect the following components, 2 symmetrical adjustable air intake compression ramps attached to the outer edges of the engines' center, an axial flow air compressor connected in between said air compression ramps, a linear aerospike nozzle which gimbles and provides the only exhaust expansion ramp for the engine, 2 air breathing combustors located at the ends of the air compression ramps and on the outside edges of the main combustion chambers for the linear aerospike nozzle, 1 liquid hydrogen turbopump, 1 liquid oxygen turbopump turbine which drives either the air compressor or the main liquid oxygen pump, 1 clutch for the air compressor to engage the air compressor to the liquid oxygen turbopump, several linear actuators to change the air compression ramp geometry, and a control system to control basic engine functions, such as throttles for both air and fuel, air intake ramp shape, axial flow air supply valves, and the clutch for turbopump.

2. A turbopump turbine described in claim 1, which either drives an air compressor or a liquid oxygen pump for the rocket that is controlled by a clutch, but does not drive both pump and air compressor simultaneously.

3. An air supply from claim 1 consisting of several movable rectangular ramps on each side connected to each other by hinges which compress the incoming air by a ram effect and can be moved by the attached linear actuators to change the air compression ramp geometry.

4. A linear aerospike rocket nozzle in claim 1 that serves as an exhaust expansion ramp for both said air breathing ram jets and said liquid rocket while having the ability to gimble to vector the rocket thrust without changing the air breathing exhaust ramp geometry.
